(19) United States
(12) Patent Application Publication
(10) Pub. No.: US 2013/0259563 A1
(43) Pub. Date: Oct. 3, 2013

(54) UNIVERSAL CONSTRUCTION BRACKET METHOD AND APPARATUS

(71) Applicant: JOHN HOLLAND CAMPBELL, LAFAYETTE, LA (US)

(72) Inventor: JOHN HOLLAND CAMPBELL, LAFAYETTE, LA (US)

(21) Appl. No.: 13/848,386

(22) Filed: Mar. 21, 2013

Related U.S. Application Data
(60) Provisional application No. 61/613,553, filed on Mar. 21, 2012.

(51) Int. Cl. F16B 7/00

(52) U.S. Cl. CPC F16B 7/00
USPC 403/188

(57) ABSTRACT

A universal bracket system can be used to create multiple interlocking bracket assemblies for construction of buildings, dwellings, structures and other objects. A primary planar bracket plate member has flange extensions and holes for bolts or other fasteners. Multiple supplementary bracket plate members are variations of the primary bracket plate member. A ridge bracket plate member is provided. Primary and supplementary plate members, as well as the ridge bracket plate member, can be combined in multiple interlocking configurations to create brackets for connecting structural members into many different connection joints.

### CROSS REFERENCES TO RELATED APPLICATION

Priority of U.S. Provisional Patent Application Ser. No. 61/613,553, filed Mar. 21, 2012, incorporated herein by reference, is hereby claimed.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a universal bracket system. More particularly, the present invention pertains to a universal bracket system that can be used to join timbers or other structural members for the construction of buildings and/or other structures. More particularly still, the present invention pertains to a universal bracket system comprising bracket plates that can be optionally interlocked to form different brackets which, in turn, can be used to form multiple joint configurations or junction points for structural members.

2. Brief Description of the Prior Art

During the construction of buildings, dwellings and other structures, a structural frame is frequently erected. Such frame, which typically comprises interconnected timbers, boards or other sturdy members, provides structural support and a stable frame to which interior and exterior wall coverings and roof members can be attached. The use of standardized dimensional support members to create such a support frame allows builders to enclose large areas with minimal cost, while achieving a wide variety of architectural styles.

In many cases, such structural frame members are joined together using connectors including, without limitation, timber brackets, wood connector brackets, framing brackets, joist brackets, joist connectors and/or iron beam connectors. Frequently, bolts or other fasteners are used to tie or attach such connectors to said structural frame members. Unfortunately, such existing connectors have different configurations for different uses. Such connectors are generally not interchangeable, and often must be custom made in order to fit particular design elements or architectural applications.

Further, conventional connectors frequently must be bent, drilled or otherwise modified in order to accommodate certain connection types or frame configurations. Such conventional bracket members also regularly require timbers or other structural members to be cut, reconfigured or “dressed off” to fit particular connection configurations. Use of such conventional connectors is frequently time consuming, costly and labor intensive.

Thus, there is a need for a universal bracket system that can be used to join structural frame members during the construction of buildings, dwellings or other structures. Such universal bracket system should be affordable, easy to manufacture and convenient to use, while minimizing generation of waste. Further, such universal bracket system should allow for a wide range of possible applications and architectural features.

### SUMMARY OF THE PRESENT INVENTION

The present invention comprises a universal bracket system for construction of buildings, dwellings, structures or other objects. The interlocking bracket assemblies of the present invention can be used for joining or connecting structural members. Although the universal construction bracket system of the present invention can be used to construct many different objects, it is particularly beneficial for constructing bays of uniform structure and exhibits a number of advantages over conventional building systems.

In the preferred embodiment, the universal bracket system of the present invention comprises a primary bracket plate member and a plurality of supplemental or secondary bracket plate members. Said primary bracket plate member is substantially planar and constructed of steel or other rigid material having desired characteristics. The thickness of said primary bracket plate member can be beneficially adjusted to provide desired strength characteristics, as well as appearance for applications in which such primary bracket plate member will be visible.

Said primary bracket plate member comprises a central body section having first and second wing-like lateral flange members. Said lateral flange members can include holes or apertures extending through said flange members. In the preferred embodiment, said holes are oriented in vertically aligned pairs, with one such pair extending through each flange member.

Said primary bracket plate member further comprises a crown flange extension member and a base flange extension member, both of which extend outward from said body section. Said crown and base flange extension members are axially aligned, and both have holes extending through said crown and base extension members. In the preferred embodiment, a vertically aligned pair of holes extends through said crown flange extension member, while a single hole extends through said base flange extension member.

Said primary bracket plate member further comprises a pair of aligned slots extending from the base of said bracket plate member into said central body section to approximately mid-way through said central body member. Said slots are oriented substantially parallel to each other, and are disposed on both sides of said base flange extension.

In addition to said primary bracket plate member, said universal bracket construction system of the present invention comprises a plurality of supplementary bracket plate members that substantially comprise variations of said primary bracket plate member. In some cases, said supplementary bracket plate members comprise truncated embodiments of said primary bracket plate member with one or more flange members removed. Additionally, a ridge bracket plate member is provided. The bracket plate members of the present invention can be combined in various interlocking configurations to create brackets for connecting timbers, boards or other structural members in a number of different connection joints.

In the preferred embodiment, the universal bracket construction system of the present invention allows for construction of a six (6) post capacity connection, as well as many other common connections. Connections formed using brackets of the present invention are extremely sturdy and capable of resisting lateral loads (wind and seismic), while providing resistance against corrosion.

The universal bracket construction system of the present invention provides required bearing area for beams, as well as required uplift (tension) resistance. As such, structures manufactured using brackets of the present invention can satisfy applicable code(s), regulatory requirement(s) and professional design specifications. The universal bracket system of the present invention is also easily scalable and can be used in connection with custom projects or prefabricated kits for use in virtually any building project.

The universal bracket system of the present invention is affordable, as well as easy to manufacture and use. Further, the universal bracket system of the present invention permits precision construction, including customized solutions, as well as the ability to be retrofitted for repairs, remodeling, and especially for additions. Said construction system reduces post cuts and drill hole, generally does not require bracket or fastener bending, and significantly reduces material waste.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a side view of a primary bracket plate member of the present invention.

FIG. 2 depicts a side view of a first supplementary bracket plate member of the present invention.

FIG. 3 depicts a side view of a second embodiment of a supplementary bracket plate member of the present invention.

FIG. 4 depicts a side view of a third embodiment of a supplementary bracket plate member of the present invention.

FIG. 5 depicts a side view of a fourth embodiment of a supplementary bracket plate member of the present invention.

FIG. 6 depicts a side view of a ridge bracket plate member.

FIG. 7 depicts a side perspective view of a center post interlocking bracket assembly of the present invention.

FIG. 8 depicts a side perspective view of a center post connection formed using the interlocking bracket assembly depicted in FIG. 7.

FIG. 9 depicts a side perspective view of a mid-wall interlocking (post splice) bracket assembly of the present invention.

FIG. 10 depicts a side perspective view of a mid-wall post splice connection formed using the interlocking bracket assembly depicted in FIG. 9.

FIG. 11 depicts a side perspective view of a right corner rafter interlocking bracket assembly of the present invention.

FIG. 12 depicts a side perspective view of a right corner rafter connection formed using the interlocking bracket assembly depicted in FIG. 11.

FIG. 13 depicts a side perspective view of a mid-wall rafter interlocking bracket assembly of the present invention.

FIG. 14 depicts a side perspective view of a mid-wall rafter connection formed using the interlocking bracket assembly depicted in FIG. 13.

FIG. 15 depicts a side perspective view of a rafter ridge interlocking bracket assembly of the present invention.

FIG. 16 depicts a side perspective view of a rafter ridge connection formed using the interlocking bracket assembly depicted in FIG. 15.

### DETAILED DESCRIPTION OF A PREFERRED EMBODIMENT OF THE INVENTION

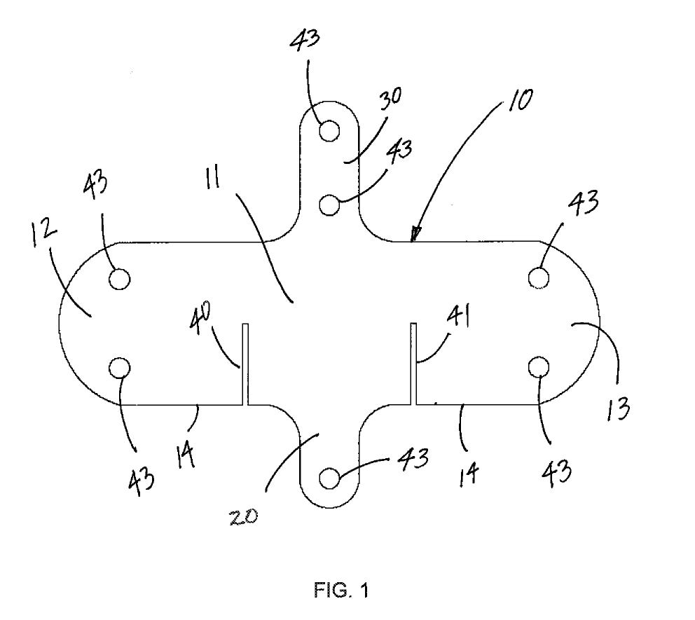

FIG. 1 depicts a side view of a primary bracket plate member 10 of the present invention. Said primary bracket plate member 10 is substantially planar and constructed of steel or other rigid material having desired strength and appearance characteristics. The thickness of said primary bracket plate member 10 can be beneficially adjusted to provide desired strength characteristics, as well as appearance for applications in which such primary bracket plate member 10 will be visible.

Said primary bracket plate member comprises a central body section 11 having a first lateral flange member 12 and a second lateral flange member 13. Said lateral flange members 12 and 13 can include holes or apertures 43 extending through said flange members. In the preferred embodiment, said holes 43 disposed through said lateral flange members 12 and 13 are oriented in vertically-aligned pairs, with one pair of vertically aligned holes 43 extending through each lateral flange member. Said holes 43 can be beneficially designed for receiving a fastener such as, for example, a threaded bolt.

Said primary bracket plate member 10 further comprises a crown flange member 30 and a base flange member 20, both of which extend outwardly from central body section 11. In the preferred embodiment of said primary bracket plate member 10, said crown flange member 30 and base flange member 20 are axially aligned, and both have holes 43 extending through said crown and base flange members. With respect to crown flange member 30, holes 43 are oriented in an aligned pair and extend through said crown flange member 30. A single hole 43 extends through said base flange member 20.

Said primary bracket plate member 10 further comprises a pair of aligned slots 40 and 41 extending from bottom edge 14 of said bracket plate member 10 into said central body section 11 to approximately mid-way through said central body member 11. Said slots are oriented substantially parallel to each other; first lateral slot 40 is disposed to the left side of said base flange member 20 in the orientation depicted in FIG. 1, while second lateral slot 41 is disposed to the right of said base flange member 20 in the orientation depicted in FIG. 1.

In addition to said primary bracket plate member 10, said universal bracket construction system of the present invention comprises a plurality of supplementary bracket plate members that substantially comprise variations of said primary bracket plate member. In many cases, said supplementary bracket plate members comprise truncated embodiments of said primary bracket plate member 10 with one or more of the aforementioned flange members removed. Additionally, a ridge bracket plate member is provided. The bracket plate members of the present invention can be combined in various interlocking configurations to join and secure timbers, boards or other structural members in a wide array of different connection joints.

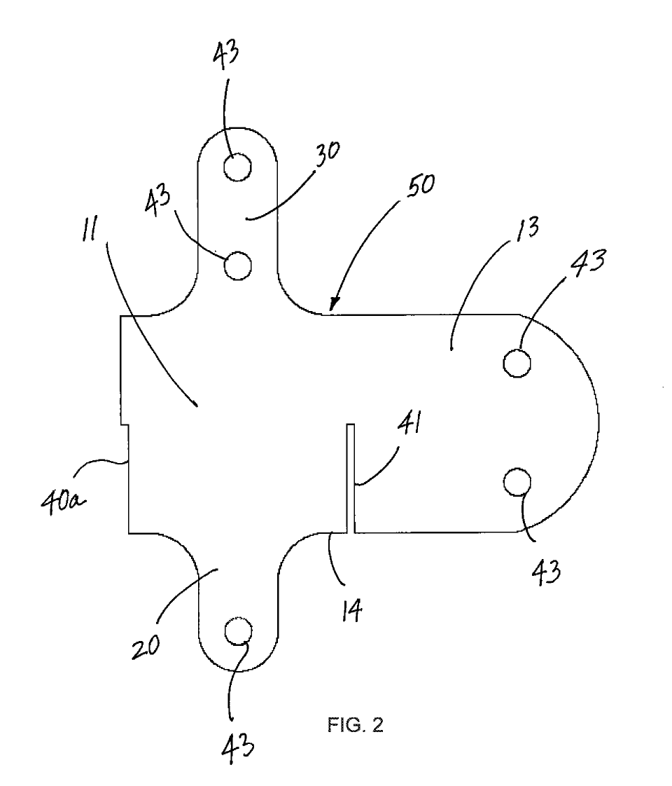

FIG. 2 depicts a side view of a first supplementary bracket plate member 50 of the present invention. First supplementary bracket plate member 50 substantially mimics primary bracket plate member 10 having central body section 11, second lateral flange member 13 (with holes 43), crown flange member 30 (with holes 43), base flange member 20 (with holes 43), and slot 41 extending from bottom edge 14. However, as depicted in FIG. 2, first supplementary bracket plate member 50 does not include lateral flange member 12 that is present on said primary bracket plate member 10; said first supplementary bracket plate member 50 is cut vertically through slot 40, leaving lateral notch 40a.

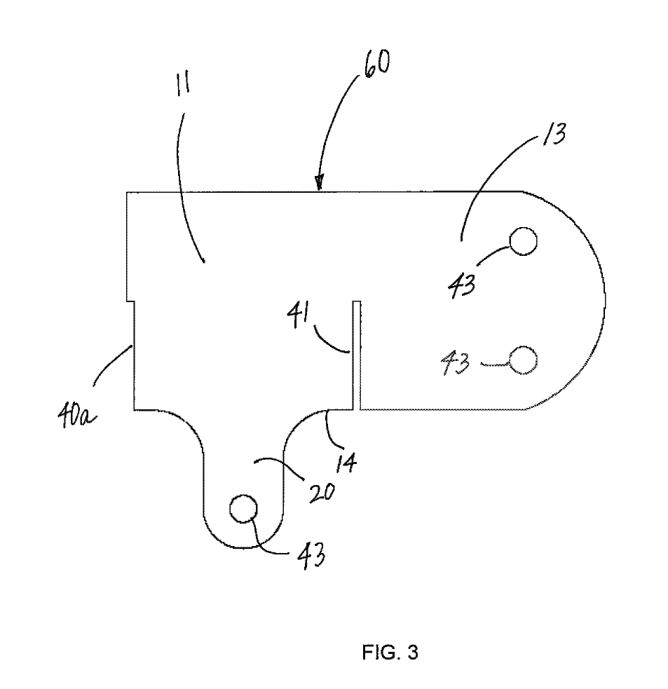

FIG. 3 depicts a side view of a second supplementary bracket plate member 60 of the present invention. Said second supplementary bracket plate member 60 substantially mimics primary bracket plate member 10, having central body section 11, lateral flange member 13 (with holes 43), base flange member 20 (with holes 43), and slot 41 extending from bottom edge 14. However, as depicted in FIG. 3, said second supplementary bracket plate member 60 does not include crown flange member 30 and lateral flange member 12 that are present on said primary bracket plate member 10; said second supplementary bracket plate member 60 is cut vertically through slot 40, leaving lateral notch 40a.

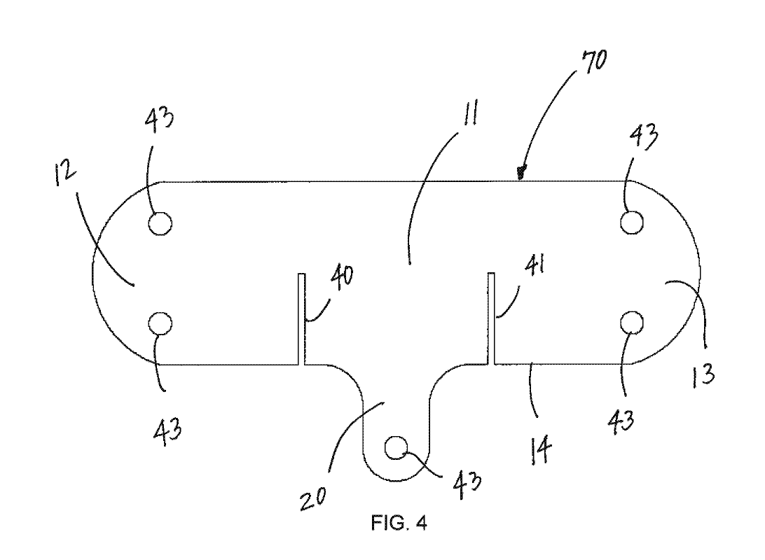

FIG. 4 depicts a side view of a third supplementary bracket plate member 70 of the present invention. Said third supplementary bracket plate member 70 substantially mimics primary bracket plate member 10 having central body section 11, lateral flange member 13 (with holes 43), lateral flange member 12 (with holes 43), base flange member 20 (with holes 43), and substantially parallel slot 40 and slot 41 extending from bottom edge 14. However, as depicted in FIG. 4, said third supplementary bracket plate member 70 does not include crown flange member 30 that is present on said primary bracket plate member 10.

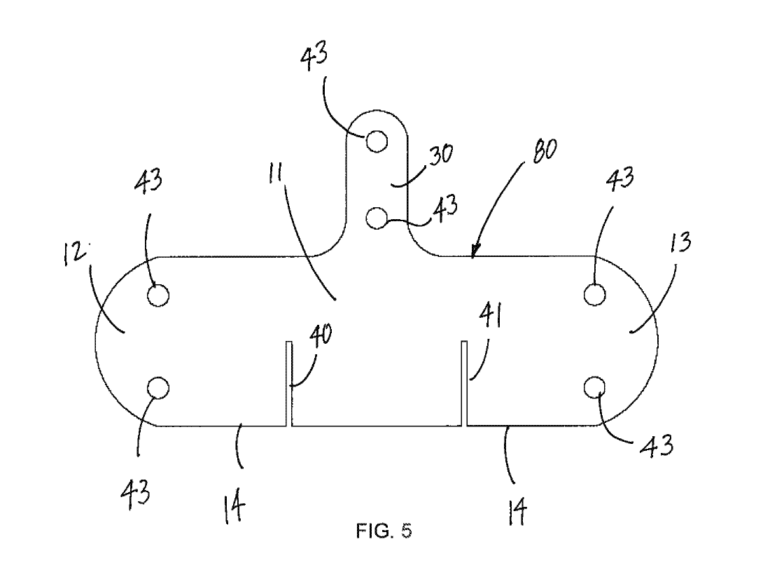

FIG. 5 depicts a side view of a fourth supplementary bracket plate member 80 of the present invention. Said fourth supplementary bracket plate member 80 substantially mimics primary bracket plate member 10 having central body section 11 lateral flange member 13 (with holes 43), lateral flange member 12 (with holes 43), crown flange member 30 (with holes 43), and substantially parallel left slot 40 and right slot 41 extending from bottom edge 14. However, as depicted in FIG. 5, said fourth supplementary bracket plate member 80 does not include base flange member 20 that is present on said primary bracket plate member 10.

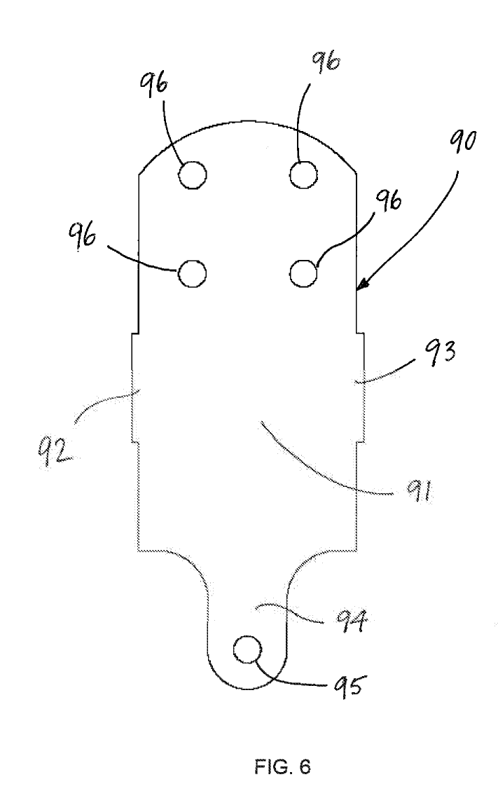

FIG. 6 depicts a side view of a ridge bracket plate member 90. Said ridge bracket plate member 90 comprises a central body section 91 having a lateral elongate tab member 92 and a lateral elongate tab member 93. Said ridge bracket plate member 90 further comprises a base flange member 94 which extends outward from central body section 91. In the preferred embodiment of said ridge bracket plate member 90, a single hole 95 extends through said base flange member 94, while a pattern of holes 96 extend through the upper portion of central body section 91. In the preferred embodiment, said holes 96 are configured in a substantially square pattern.

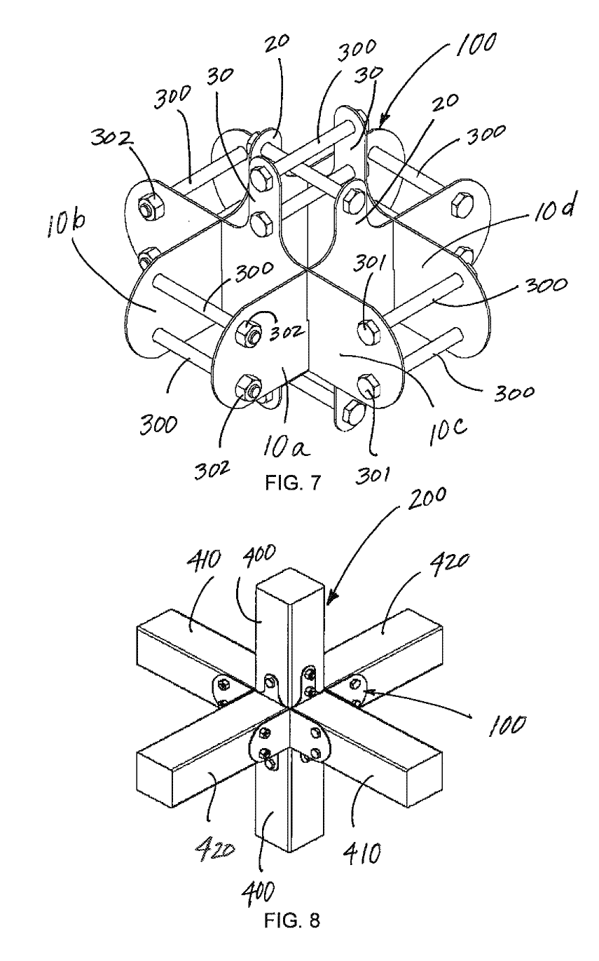

FIG. 7 depicts a side perspective view of a center post interlocking bracket assembly 100 of the present invention. Said interlocking bracket assembly 100 is beneficially formed by interlocking four (4) substantially identical primary bracket plate members 10a, 10b, 10c and 10d of the present invention. As depicted in FIG. 7, plate members 10a and 10b are substantially parallel to each other, while plate members 10c and 10d are substantially parallel to each other. Plate members 10a and 10b are oriented substantially perpendicular to plate members 10c and 10d.

Still referring to FIG. 7, plate members 10a and 10b are inverted relative to plate members 10c and 10d. As depicted in FIG. 1, each of said primary plate members 10 has elongate slots 40 and 41. In the configuration depicted in FIG. 7, plate members 10a and 10b are received within slots 40 and 41 of plate members 10c and 10d, while plate members 10c and 10d are received within slots 40 and 41 of plate members 10a and 10b. In this manner, said primary bracket plate members 10a, 10b, 10c and 10d are joined in interlocking relationship to form bracket assembly 100. It is to be observed that the width of said slots 40 and 41 can be varied for different applications, but in all applications or configurations said slots should be sufficiently wide to accommodate the thickness of plate members to be received within said slots.

As depicted in FIG. 7, holes 43 of each respective pair of parallel plate members are aligned; that is, holes 43 of plate member 10a are aligned with holes 43 of (parallel) plate member 10b, while holes 43 of plate member 10c are aligned with holes 43 of (parallel) plate member 10d. Fasteners 300 are received within said aligned holes. Said fasteners 300 are depicted in FIG. 7 as threaded bolts having heads 301, and being secured in place using threaded nuts 302. However, it is to be observed that other types of fasteners can be used in other applications including, without limitation, lag bolts, rods, screws or other fasteners.

Additionally, because plate members 10a and 10b are inverted relative to plate members 10c and 10d, and vice versa, base flange members 20 and crown flange members 30 of said (parallel) plate members 10a and 10b are aligned with one another. Similarly, base flange members 20 and crown flange members 30 of said (parallel) plate members 10c and 10d are aligned with one another. Accordingly, due to such relative inversion, fasteners extending from said aligned base and crown members (or other areas) from one pair of parallel plate members do not interfere or intersect with fasteners extending from the other pair of plate members.

FIG. 8 depicts a side perspective view of a center post connection 200 formed using interlocking bracket assembly 100 depicted in FIG. 7. Said interlocking bracket assembly 100 is used to connect and secure timbers 400, 410 and 420. As depicted in FIG. 8, said interlocking bracket assembly 100 can be used to form a joint that connects/secures up to six (6) of said timber members. Specifically, as depicted in FIG. 8, timber members 400 are oriented substantially vertically, while timber members 410 and 420 are oriented substantially horizontally and perpendicular to each other. It is to be observed that one timber member (for example, vertical timber member 400) can be a continuous member that extends through interlocking bracket assembly 100, while said other timber members 410 and 420 can be “spliced” at said connection and joined by interlocking bracket assembly 100. Alternatively, all of said timber members 400, 410 and 420 can terminate at said connection and be “spliced” or joined by interlocking bracket assembly 100.

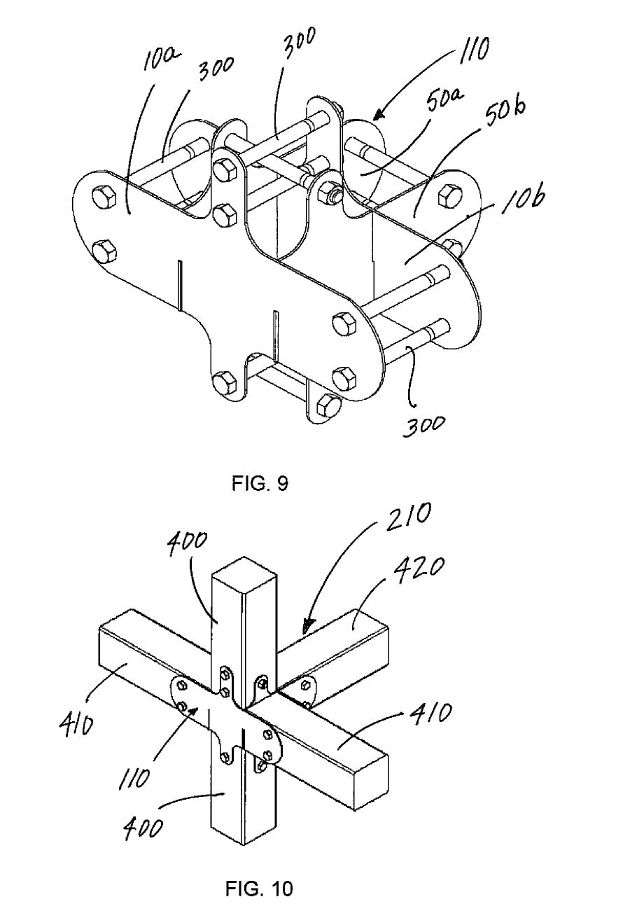

FIG. 9 depicts a side perspective view of a mid-wall (post splice) interlocking bracket assembly 110 of the present invention. Interlocking bracket assembly 110 can be formed using two (2) primary plate members 10a and 10b that are aligned substantially parallel to each other. Two (2) first supplementary bracket plate members 50a and 50b are inverted relative to said primary plate members 10a and 10b. Further, said first supplementary plate members 50a and 50b are oriented substantially parallel to one another, and substantially perpendicular to primary plate members 10a and 10b. Fasteners 300 are received in aligned holes in said plate members.

FIG. 10 depicts a side perspective view of a mid-wall post splice connection 210 formed using interlocking bracket assembly 110 depicted in FIG. 9. Timber members 400 are oriented substantially vertically, while timber members 410 and timber member 420 are oriented substantially horizontally and perpendicular to each other.

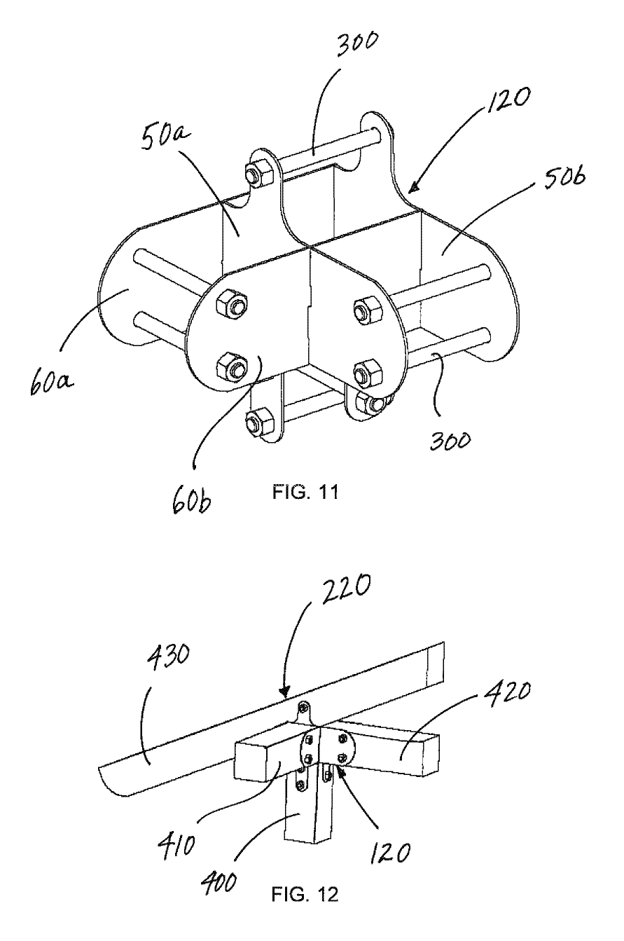

FIG. 11 depicts a side perspective view of a right corner rafter interlocking bracket assembly 120 of the present invention. Interlocking bracket assembly 120 can be formed using two (2) first supplemental plate members 50a and 50b that are aligned substantially parallel to each other. Two (2) second supplementary bracket plate members 60a and 60b are inverted relative to said plate members 50a and 50b. Further, said second supplementary plate members 60a and 60b are oriented substantially parallel to one another, and substantially perpendicular to plate members 50a and 50b. Fasteners 300 are received in aligned holes in said plate members.

FIG. 12 depicts a side perspective view of a right corner rafter connection 220 formed using interlocking bracket assembly 120 depicted in FIG. 11. Timber member 400 is oriented substantially vertically, while timber member 410 and timber member 420 are oriented substantially horizontally and perpendicular to each other. Interlocking bracket assembly 120 also joins and secures rafter member 430 as part of said right corner rafter connection 220.

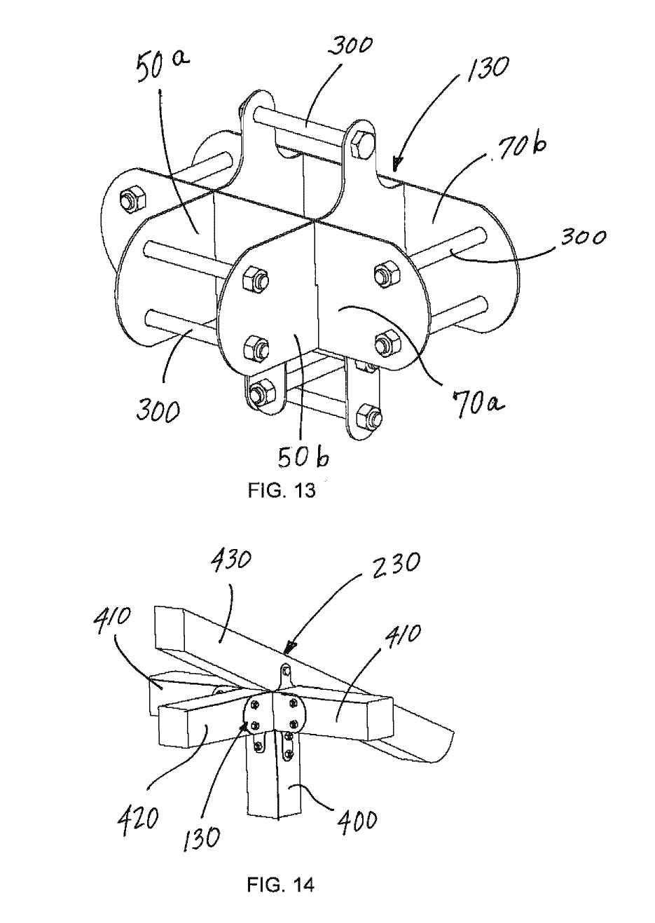

FIG. 13 depicts a side perspective view of a mid-wall rafter interlocking bracket assembly 130 of the present invention. Interlocking bracket assembly 130 can be formed using two (2) first supplemental plate members 50a and 50b that are aligned substantially parallel to each other. Two (2) third supplementary bracket plate members 70a and 70b are inverted relative to said plate members 50a and 50b. Further, said third supplementary plate members 70a and 70b are oriented substantially parallel to one another, and substantially perpendicular to plate members 50a and 50b. Fasteners 300 are received in aligned holes in said plate members.

FIG. 14 depicts a side perspective view of a mid-wall rafter connection 230 formed using interlocking bracket assembly 130 depicted in FIG. 13. Timber member 400 is oriented substantially vertically, while timber members 410 and timber member 420 are oriented substantially horizontally and perpendicular to each other. Interlocking bracket assembly 130 also joins and secures rafter member 430 as part of said mid-wall rafter connect 230.

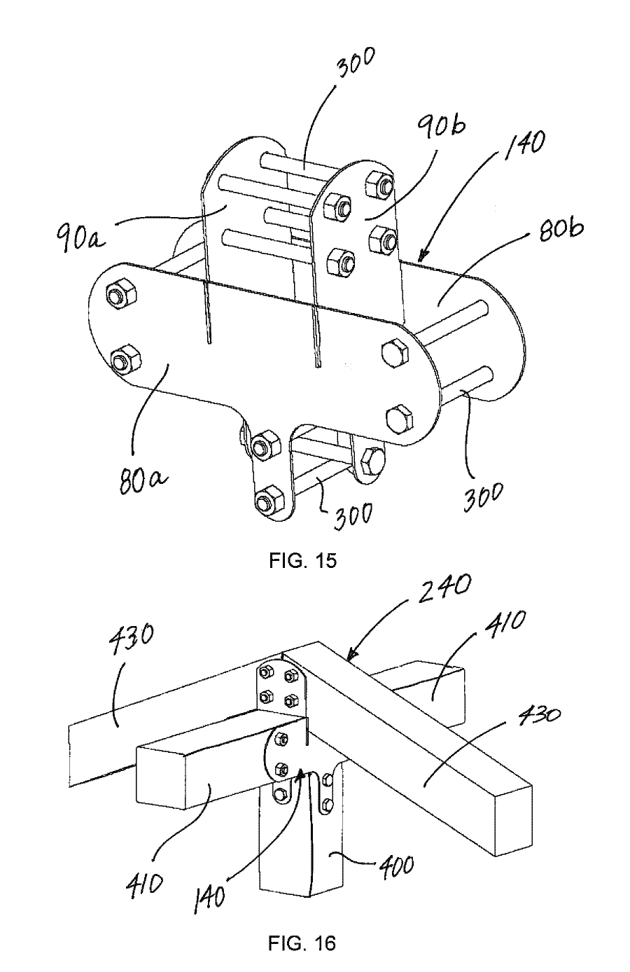

FIG. 15 depicts a side perspective view of a rafter ridge interlocking bracket assembly 140 of the present invention. Interlocking bracket assembly 140 can be formed using two (2) fourth supplemental plate members 80a and 80b that are aligned substantially parallel to each other. Two (2) ridge bracket plate members 90a and 90b are oriented substantially parallel to one another, and substantially perpendicular to fourth supplemental plate members 80a and 80b. Lateral elongate tab members of said ridge bracket plate members 90a and 90b can be received with slots of fourth supplemental plate members 80a and 80b for additional plate member interlocking. Fasteners 300 are received in aligned holes in said plate members.

FIG. 16 depicts a side perspective view of a rafter ridge connection 240 formed using the bracket assembly 140 depicted in FIG. 15. Timber member 400 is oriented substantially vertically, while timber members 410 are oriented substantially horizontally. Interlocking bracket assembly 140 also joins and secures rafter members 430 as part of said rafter ridge connection 240.

In the preferred embodiment, the universal bracket system of the present invention allows for construction of a multi-post capacity connection. Connections formed using interlocking bracket assemblies of the present invention are capable of resisting lateral loads (wind and seismic), while providing corrosion resistance. The universal bracket system of the present invention provides structural integrity to joints, and can eliminate the need for “strapping” or other unattractive joining means, particularly in areas that are prone to hurricanes or other weather events.

Components manufactured using the interlocking bracket assemblies of the present invention can satisfy applicable code(s), regulatory requirement(s) and professional design specifications, and are easily scalable. The universal bracket system of the present invention can be used for custom construction, or as part of prefabricated construction kits. The universal bracket construction system of the present invention provides required bearing area for beams, as well as required uplift (tension) resistance.

The universal bracket system of the present invention is affordable, as well as easy to manufacture and use. Further, the universal bracket system of the present invention permits precision construction, including customized solutions, as well as the ability to be retrofitted for repairs, remodeling, and especially for additions. Said construction system reduces cuts and drill hole, does not require bending, does not require the use of separate “right” and “left” (mirror image) plate members, and significantly reduces material waste.

The universal bracket system of the present invention allows one member (for example, a vertical timber member, post, beam or other structural member) to be a continuous member that extends through an interlocking bracket assembly, while other structural members can terminate and be joined at said interlocking bracket assembly. Alternatively, all structural members meeting at an interlocking bracket assembly of the present invention can terminate at said bracket and be “spliced” or joined by said interlocking bracket assembly.

Although the universal bracket system of the present invention is described herein primarily in connection with the joining of timbers, boards, posts or the like, it is to be observed that the system of the present invention can be used in connection with structural members of virtually any composition including, without limitation, concrete, metal and/or synthetic materials. Additionally, a wide range of different fasteners other than bolts can be used without departing from the scope of the present invention.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A bracket assembly for connecting structural members comprising:
a) a first pair of substantially planar plate members having at least one hole extending through each of said plate members, wherein said plate members are oriented substantially parallel to one another;
b) a second pair of substantially planar plate members having at least one hole extending through each of said plate members, wherein said second pair of plate members are oriented substantially parallel to one another and substantially perpendicular to said first pair of plate members;
c) a fastener received in aligned holes extending through said first pair of plate members; and
d) a fastener received in aligned holes extending through said second pair of plate members.

2. The bracket assembly of claim 1, wherein said first pair of plate members has first and second slots extending into each of said first pair of plate members, and said second pair of plate members are received within said slots of said first pair of plate members.

3. The bracket assembly of claim 1, wherein said second pair of plate members has first and second slots extending into each of said second pair of plate members, and said first pair of plate members are received within said slots of said second pair of plate members.

4. The bracket assembly of claim 1, wherein each of said first pair of plate members comprises:
a) a central body section a first side, a second side, a top and a bottom;
b) a first lateral flange extending from said first side said of said central body section;
c) a second lateral flange extending from said second side of said central body section;
d) a crown flange extending from said top of said central body section; and
e) a base flange extending from said bottom of said central body section.

5. The bracket assembly of claim 4, wherein each of said second pair of plate members comprises:
a) a central body section a first side, a second side, a top and a bottom;
b) a first lateral flange extending from said first side said of said central body section;
c) a second lateral flange extending from said second side of said central body section;
d) a crown flange extending from said top of said central body section; and
e) a base flange extending from said bottom of said central body section.

6. A bracket assembly for connecting structural members comprising:
a) a first pair of substantially planar plate members having at least one hole extending through each of said plate members, wherein said plate members are oriented substantially parallel to one another and each of said plate members comprises:
i) a central body section a first side, a second side, a top and a bottom;
ii) a first lateral flange extending from said first side said of said central body section;
iii) a second lateral flange extending from said second side of said central body section;
iv) a crown flange extending from said top of said central body section; and
v) a base flange extending from said bottom of said central body section;
b) a second pair of substantially planar plate members having at least one hole extending through each of said plate members, wherein said second pair of plate members are oriented substantially parallel to one another and substantially perpendicular to said first pair of plate members;
c) a fastener received in aligned holes extending through said first pair of plate members; and
d) a fastener received in aligned holes extending through said second pair of plate members.

7. The bracket assembly of claim 6, wherein each of said second pair of plate members comprises:
a) a central body section a first side, a second side, a top and a bottom;
b) a first lateral flange extending from said first side said of said central body section;
c) a second lateral flange extending from said second side of said central body section;
d) a crown flange extending from said top of said central body section; and
e) a base flange extending from said bottom of said central body section.

8. The bracket assembly of claim 6, wherein said first pair of plate members has first and second substantially parallel slots extending into each of said first pair of plate members, and said second pair of plate members are received within said slots of said first pair of plate members.

9. The bracket assembly of claim 8, wherein said first slot is disposed on one side of said base flange and extends into said central body member from the bottom of said central body member, and said second slot is disposed on the opposite side of said base flange from said first slot and extends into said central body member from the bottom of said central body member.

10. The bracket assembly of claim 7, wherein said second pair of plate members has first and second substantially parallel slots extending into each of said second pair plate members, and said first pair of plate members are received within said slots of said second pair of plate members.

11. The bracket assembly of claim 10, wherein said first slot of each of said second pair of plate members is disposed on one side of said base flange and extends into said central body member from the bottom of said central body member, and said second slot of each of said second pair of plate members is disposed on the opposite side of said base flange from said first slot and extends into said central body member from the bottom of said central body member.

12. The bracket assembly of claim 6, wherein each of said second pair of plate members comprises:
a) a central body section a first side, a second side, a top and a bottom;
b) a lateral flange extending from a side said of said central body section;
c) a crown flange extending from said top of said central body section; and
d) a base flange extending from said bottom of said central body section.

13. The bracket assembly of claim 6, wherein each of said second pair of plate members comprises:
a) a central body section a first side, a second side, a top and a bottom;
b) a first lateral flange extending from said first side said of said central body section;
c) a second lateral flange extending from said second side of said central body section; and
d) a base flange extending from said bottom of said central body section.

14. The bracket assembly of claim 6, wherein each of said second pair of plate members comprises:
a) a central body section a first side, a second side, a top and a bottom;
b) a first lateral flange extending from said first side said of said central body section;
c) a second lateral flange extending from said second side of said central body section; and
d) a crown flange extending from said top of said central body section.

15. The bracket assembly of claim 6, wherein each of said second pair of plate members comprises:
a) a central body section a first side, a second side, a top and a bottom;
b) a crown flange extending from said top of said central body section; and
c) a base flange extending from said bottom of said central body section.

16. A bracket assembly for connecting structural members comprising:
a) a first pair of substantially planar plate members having at least one hole extending through each of said plate members, wherein said plate members are oriented substantially parallel to one another and each of said plate members comprises:
i) a central body section a first side, a second side, a top and a bottom;
ii) a first lateral flange extending from said first side said of said central body section;
iii) a second lateral flange extending from said second side of said central body section;
iv) a crown flange extending from said top of said central body section; and
v) a base flange extending from said bottom of said central body section;
b) a second pair of substantially planar plate members having at least one hole extending through each of said plate members, wherein said second pair of plate members are oriented substantially parallel to one another and substantially perpendicular to said first pair of plate members and each of said second pair of plate members comprises:
i) a central body section a first side, a second side, a top and a bottom;
ii) a first lateral flange extending from said first side said of said central body section;
iii) a second lateral flange extending from said second side of said central body section;
iv) a crown flange extending from said top of said central body section; and
v) a base flange extending from said bottom of said central body section;
c) a fastener received in aligned holes extending through said first pair of plate members; and
d) a fastener received in aligned holes extending through said second pair of plate members.

17. The bracket assembly of claim 16, wherein said first pair of plate members has first and second substantially parallel slots extending into each of said first pair of plate members, and said second pair of plate members are received within said slots of said first pair of plate members.

18. The bracket assembly of claim 17, wherein said first slot is disposed on one side of said base flange and extends into said central body member from the bottom of said central body member, and said second slot is disposed on the opposite side of said base flange from said first slot and extends into said central body member from the bottom of said central body member.

19. The bracket assembly of claim 16, wherein said second pair of plate members has first and second substantially parallel slots extending into each of said second pair plate members, and said first pair of plate members are received within said slots of said second pair of plate members.

20. The bracket assembly of claim 19, wherein said first slot of each of said second pair of plate members is disposed on one side of said base flange and extends into said central body member from the bottom of said central body member, and said second slot of each of said second pair of plate members is disposed on the opposite side of said base flange from said first slot and extends into said central body member from the bottom of said central body member.
